(19) United States
(12) Patent Application Publication
(10) Pub. No.: US 2017/0150112 A1
(43) Pub. Date: May 25, 2017

(54) Methodologies for Mobile Camera Color Management

(71) Applicant: Google Inc., Mountain View, CA (US)

(72) Inventors: Honglei Wu, Sunnyvale, CA (US); Boyd Albert Fowler, Sunnyvale, CA (US)

(21) Appl. No.: 14/952,163

(22) Filed: Nov. 25, 2015

(51) Int. Cl. H04N 9/64; H04N 5/225; H04N 1/60; H04N 9/07

(52) U.S. Cl. CPC H04N 9/646; H04N 9/07; H04N 5/2256; H04N 1/6019

(57) ABSTRACT

This document describes methodologies for mobile camera color management. These techniques and apparatuses enable improved consistency of color quality, faster color tuning process, adaptability to new light sources, and easier adoption on the production line than many conventional color management techniques.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Color management is a process commonly used for consumer cameras, which ensures that the color images are provided in human-usable format. For example, color imaging generally uses three types of pixels (e.g., red, green, and blue pixels) to form a color image. However, raw data from the camera cannot be directly used, because the camera's color response is different from that of human eyes. Because of this, a color correction process is generally performed to convert the camera's color information (e.g., raw data) into a format usable by humans. For example, color correction adjusts image colors so they replicate scene colors. The colors in captured images usually need to be made more “saturated” to give a brilliant look to the colors.

To enable performance of color correction, a process referred to as “color tuning” is generally performed to obtain parameters needed for the color correction. Color tuning, however, is conventionally a time consuming and inflexible process. For example, color tuning is time consuming because it generally involves capturing images of a standard color chart under different light sources and then performing image processing. In addition, color tuning is generally inflexible because the color tuning results are limited to the specific types of light sources used when capturing the images of the standard color chart. Because of these limitations, performance and consistency are generally sacrificed on the production line for production speed.

### BRIEF DESCRIPTION OF THE DRAWINGS

Apparatuses of and techniques using methodologies for mobile camera color management are described with reference to the following drawings. The same numbers are used throughout the drawings to reference like features and components:

FIG. 1 illustrates an example environment in which methodologies for mobile camera color management can be enabled.

FIG. 2 illustrates an example implementation of a computing device of FIG. 1 in greater detail in accordance with one or more embodiments.

FIG. 3 illustrates an example system that is usable to perform color tuning of the image sensor.

FIG. 4 illustrates an example implementation of methodologies for mobile camera color management used to obtain color correction data.

FIG. 5 illustrates an alternative example implementation of methodologies for mobile camera color management used to obtain color correction data.

FIG. 6 illustrates example methods of color tuning using methodologies for mobile camera color management.

FIG. 7 illustrates example methods of mobile camera color management for performing color correction of images captured by a camera.

FIG. 8 illustrates various components of an electronic device that can implement methodologies for mobile camera color management in accordance with one or more embodiments.

### DETAILED DESCRIPTION

### Overview

Conventional color management techniques for cameras are time consuming and inflexible, sacrificing performance and consistency on the production line for the sake of production speed. For example, color tuning of a camera generally involves using the camera to capture images of a standard color chart under different controlled light sources, and then processing the images by comparing raw color data of the images captured by the camera with reference data of the standard color chart. In some cases, this conventional color tuning process can last for 30 minutes or more for a single camera. Because of this, conventional color tuning is generally performed only on a few samples from the production line, rather than on each camera, in order to increase production speed.

In addition, the color tuning results of the conventional color tuning process are limited to the specific types of light sources used during the process. For example, if the camera has been tuned according to fluorescent lights available in the USA, and the camera is then shipped to a foreign country with a different type of fluorescent light that is not characterized for that specific camera, a failure mode may be initiated because the color correction parameters for the foreign country's fluorescent light are not available in that camera.

Consider instead, however, an example methodology for mobile camera color management. This process, instead of capturing images of the standard color chart using the camera or other imaging device, measures a spectral response curve (e.g., quantum efficiency (“QE”) curve) of the camera using a fast QE measurement technique, and then stores the QE curve in a memory of a mobile device that includes the camera. By measuring the QE curve of the camera, the process of color reproduction under any lighting condition for the camera can be simulated. By storing the QE curve at the mobile device that includes the camera, the parameters needed for color correction (also referred to as saturation correction or color saturation) can be calculated directly from the QE curve, bypassing the time-consuming conventional process of actually capturing pictures of color charts. Storing the QE curve of the camera enables the camera to be adaptable to any new type of light sources.

The methodologies for mobile camera color management described herein increase consistency, speed, flexibility, and scalability. For example, consistency of color quality is improved among devices produced on the production line by applying the techniques to each camera produced. Production time is reduced by using a fast color tuning process that simulates color correction parameters by an algorithm. Flexibility is increased by enabling the camera to adapt to a wide variety of different light sources, including light sources for which the camera is not tuned. These methodologies are scalable and can easily be adopted on the production line, yielding best-possible per-unit color tuning without sacrificing speed of production.

The following discussion first describes an operating environment, followed by techniques that may be employed in this environment. This discussion continues with an example electronic device in which methodologies for mobile camera color management can be embodied.

### Example Environment

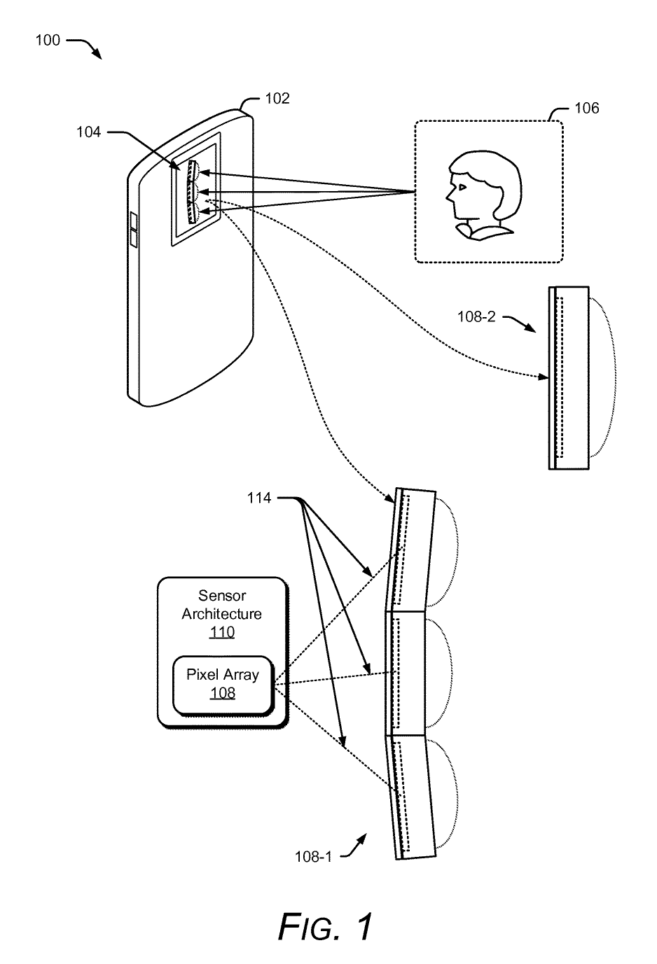

FIG. 1 illustrates an example environment 100 in which methodologies for mobile camera color management can be embodied. The example environment 100 includes a mobile device 102 having an image sensor 104 capable of capturing images of a scene 106. The image sensor 104 includes a pixel array 108, two examples of which are shown, a multi-array pixel array 108-1, and a single lens, large pixel array 108-2. The multi-array pixel array 108-1 includes three detectors within three lens elements. The single lens, large pixel array 108-2 includes one detector and one lens element. While two example pixel arrays 108 are shown, many are contemplated, including a single pixel array having many pixels, each of the pixels being a light detector with a micro-lens element, such as a charge-coupled device (CCD) or CMOS (Complementary Metal-Oxide-Semiconductor) active-pixel sensors.

The image sensor 104 includes a sensor architecture 110, which includes the pixel array 108. The sensor architecture 110 receives image-data streams 112 of images captured of the scene 106 by the pixel array 108, which is internal to the sensor architecture 110.

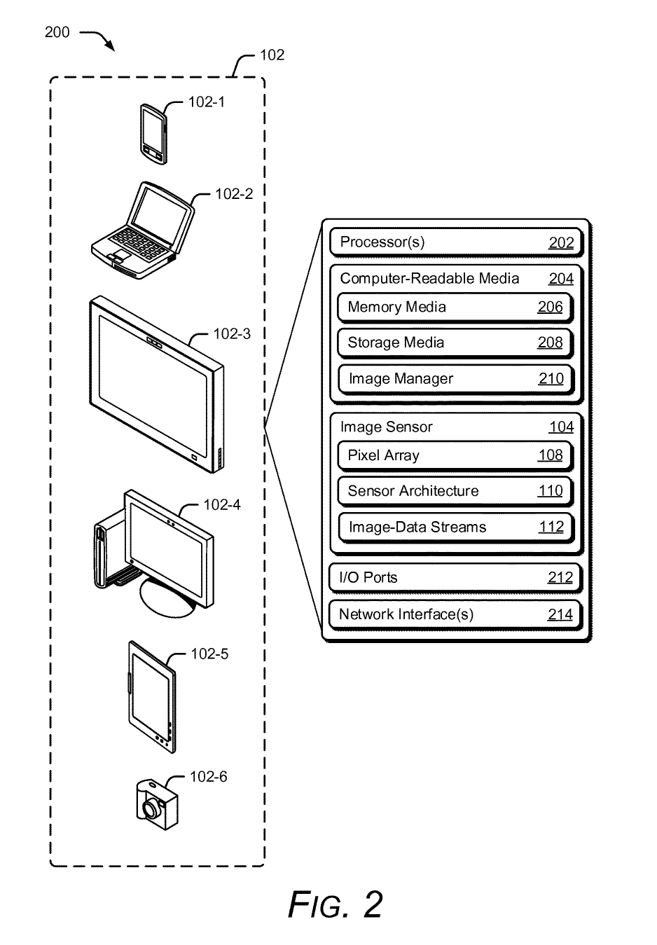

Having generally described an environment in which methodologies for mobile camera color management may be implemented, this discussion now turns to FIG. 2, which illustrates an example implementation 200 of the mobile device 102 of FIG. 1 in greater detail in accordance with one or more embodiments. The mobile device 102 is illustrated with various non-limiting example devices: smartphone 102-1, laptop 102-2, television 102-3, desktop 102-4, tablet 102-5, and camera 102-6. The mobile device 102 includes processor(s) 202 and computer-readable media 204, which includes memory media 206 and storage media 208. Applications and/or an operating system (not shown) embodied as computer-readable instructions on the computer-readable media 204 can be executed by the processor(s) 202 to provide some or all of the functionalities described herein, as can partially or purely hardware or firmware implementations. The computer-readable media 204 also includes image manager 210, which can perform computations to improve image quality using a QE curve stored in the storage media 208 for color correction of images captured by the image sensor 104.

As noted above, the mobile device 102 includes the image sensor 104, which includes the pixel array 108 within the sensor architecture 110, and the image-data streams 112. The mobile device 102 also includes I/O ports 212 and network interfaces 214. I/O ports 212 can include a variety of ports, such as by way of example and not limitation, high-definition multimedia (HDMI), digital video interface (DVI), display port, fiber-optic or light-based, audio ports (e.g., analog, optical, or digital), USB ports, serial advanced technology attachment (SATA) ports, peripheral component interconnect (PCI) express based ports or card slots, serial ports, parallel ports, or other legacy ports. The mobile device 102 may also include the network interface(s) 214 for communicating data over wired, wireless, or optical networks. By way of example and not limitation, the network interface 214 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like.

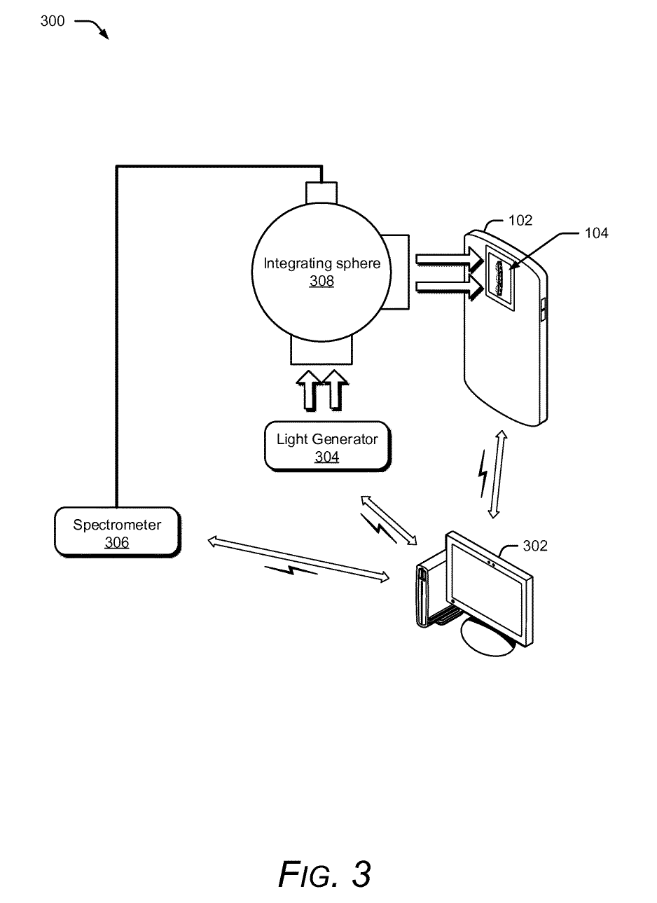

Having described the mobile device 102 of FIG. 2 in greater detail, this discussion now turns to FIG. 3, which illustrates an example system 300 that is usable to perform color tuning of the image sensor 104. Color tuning is the process of obtaining parameters usable for color correction of images captured by the image sensor 104. In the illustrated example, a computing device 302 is communicably connected a light generator 304, a spectrometer 306, and a mobile device such as mobile device 102 from FIG. 1. The computing device 302 can communicate with the other components of the example system 300 via a wired connection, a wireless connection such as those described above, or a combination of wired and wireless connections.

The light generator 304 can include any of a variety of different types of light generators. The light generator 304 can include a programmable narrow band light generator, a rapid light-emitting diode (LED) light source, and so on. The light generator 304 is used to simulate a variety of different light sources having different lighting characteristics such as color, brightness, intensity, temperature, hue, and so on. The light produced by the light generator 304 is sent to an integrating sphere 308 that diffuses the light. The integrating sphere 308 uniformly scatters (e.g., diffuses) the light by equally distributing the light over points on an inner surface of the sphere to preserve optical power by destroying spatial information. The integrating sphere 308 is connected, such as via an optical cable, to the spectrometer 306, which is used for measuring the optical power of the diffused light. Additionally, the integrating sphere 308 allows the diffused light to exit directly onto the image sensor 104 of the mobile device 102.

While the spectrometer 306 can be used to measure the optical power of the diffused light, the computing device 302 can communicate with the mobile device 102 to measure a spectral response of the image sensor 104. The spectrometer 306 identifies reference data that is usable to indicate an expected spectral response, while the computing device 302 measures the actual spectral response of the image sensor 104. Subsequently, the computing device 302 can plot a curve representing the spectral response for the image sensor 104 of the mobile device 102. This curve is referred to herein as the spectral response curve or the QE curve.

Once the QE curve is measured and generated, the QE curve is stored on the mobile device 102, such as in the storage memory 208 of the mobile device 102 of FIG. 2. By storing the QE curve on the mobile device 102, the mobile device 102 can subsequently access the QE curve to derive parameters usable for color correction of images captured by the mobile device 102 to self-adjust to new light sources or new lighting environments.

Using this example system 300, a wide variety of different light sources can be simulated, and the image sensor 104 of the mobile device 102 can be exposed to the simulated light sources, all in approximately one second or less, whereas conventional techniques for color tuning can take 30 minutes or more. Because of this, the process of color reproduction under any lighting condition can be quickly simulated for each and every camera produced on a production line, rather than for just a few samples as is commonly done by traditional color tuning processes. Accordingly, consistency of color quality over cameras produced on the production line is improved without sacrificing production speed.

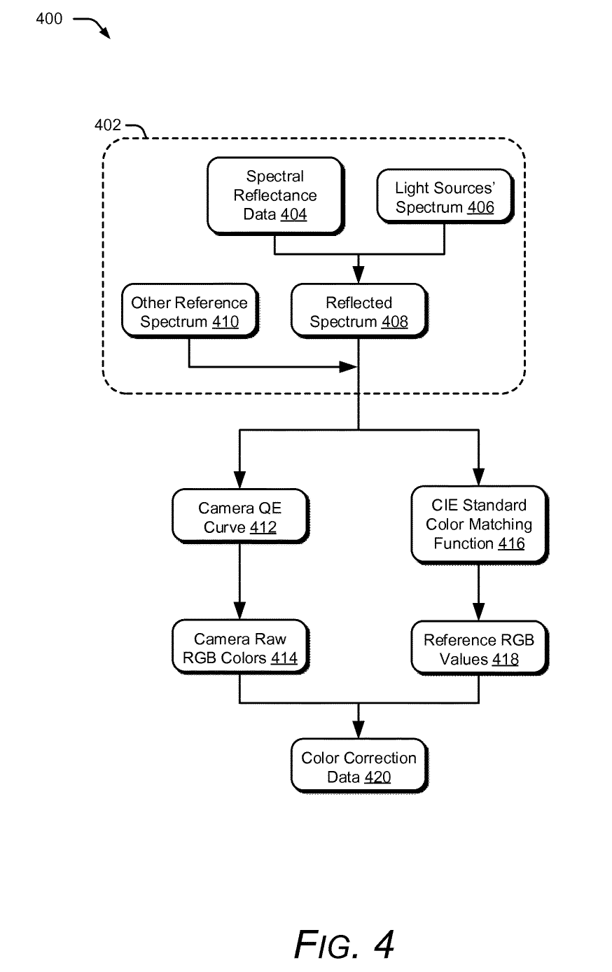

Having described an example system in which methodologies for mobile camera color management can be employed, this discussion now turns to FIG. 4, which illustrates an example implementation 400 of methodologies for mobile camera color management used to obtain color correction data. For example, a reference spectrum generator 402 can be used to obtain spectral reflectance data 404 and light sources' spectrum 406 from a database of reference data. The spectral reflectance data 404 represents measurements of color of physical objects, such as leaves, rocks, walls, and so on. The light sources' spectrum 406 represents measurements of a light spectrum of respective light sources. These measurements can be used as reference values for various different light sources because artificial light sources generally do not produce a full spectrum of visible light, since production of artificial light sources having a full spectrum of light is less efficient.

The spectral reflectance data 404 and the light sources' spectrum 406 can be used to determine reflected spectrum 408, which includes reference values that represent various light sources' light reflecting off of various surfaces. In addition, other reference spectrums 410 can be used to optimize for different spectrum in the natural world. Using the reflected spectrum 408 together with other reference spectrums 410, a variety of different spectrums are obtained that have reference values. Then, a camera QE curve 412 that was previously stored in memory is accessed to extract camera raw RGB colors 414. In addition, a CIE standard color matching function 416, corresponding to a color space defined by the International Commission on Illumination (CIE), is used to identify reference RGB values 418 that represent optimized values of what the camera raw RGB colors should be, based on the reflected spectrum 408 and the other reference spectrums 410. A three-dimensional lookup table can be used to obtain parameters usable for color correction of images captured by the camera. The reference RGB values 418 can then be used with the camera raw RGB colors 414 to generate color correction data 420 (e.g., parameters for color correction). The color correction data 420 is usable to fine tune the colors of captured images for the human eye.

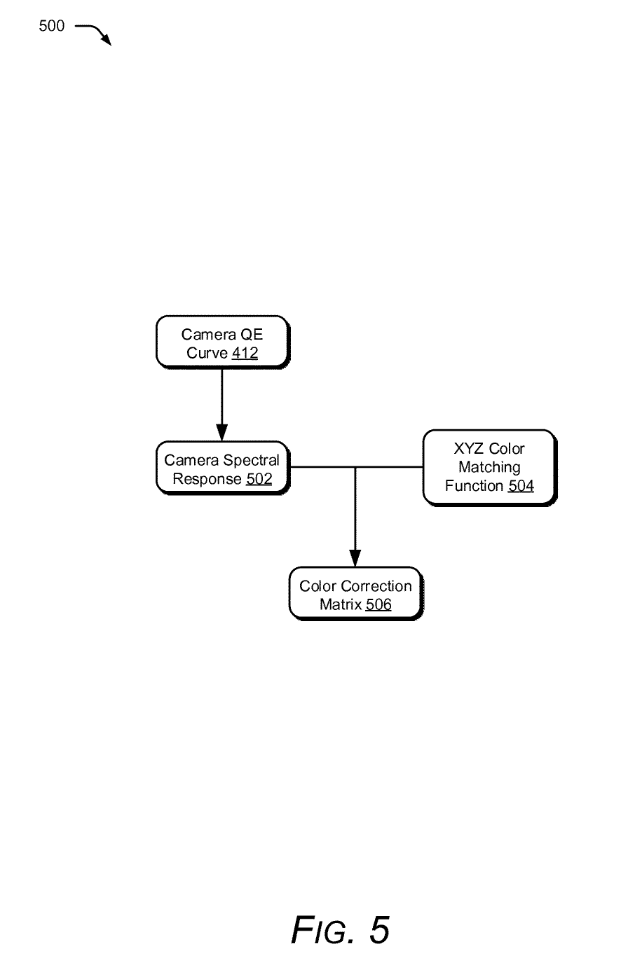

FIG. 5 describes an alternative embodiment 500 for implementing methodologies for mobile camera color management. The camera QE curve 412 can be access to obtain the spectral response of the camera, such as camera spectral response 502. Reference data can be obtained from an XYZ color matching function 504 corresponding an XYZ color space. Then, the camera spectral response 502 and the XYZ color matching function 504 are used to derive a color correction matrix 506. For example, the color correction matrix 506 can be derived using the following equation:

C*CSR≈CMF Equation 1

In equation 1, the term C refers to the color correction matrix 506, the term CSR refers to the camera spectral response 502, and the term CMF refers to the XYZ color matching function 504. The color correction matrix 506 can then be used for color correction of the images captured by the camera, such as to convert raw RGB data into a format usable by humans.

In implementations, the color correction matrix 506 can include a 3×3 matrix operation, such as in the following equation:

R_{cc}=A₁₁*R₀+A₁₂*G₀+A₁₃*B₀

G_{cc}=A₂₁*R₀+A₂₂*G₀+A₂₃*B₀

B_{cc}=A₃₁*R₀+A₃₂*G₀+A₃₃*B₀ Equation 2

In Equation 2, the terms R_{cc}, G_{cc}, and B_{cc}represent color corrected output signals, the terms A₁₁−A₃₃ refer to matrix coefficients for the color correction matrix, and the terms R₀, G₀, and B₀ refer to the camera output signals (which may have already undergone other processing steps such as white balance). The challenge of color correction in this example is to determine the color correction matrix coefficients. The matrix coefficients can be computed by a mathematical mapping of the sensor response function (e.g., QE curve) onto the color matching function of an output device, such as a display device of the camera. The matrix coefficients change for different lenses and IR filters used, for different output devices such as monitors and printers, and for different types of sensors and color filter options. The matrix coefficients are therefore variable under different applications and hardware usage.

### Example Methods

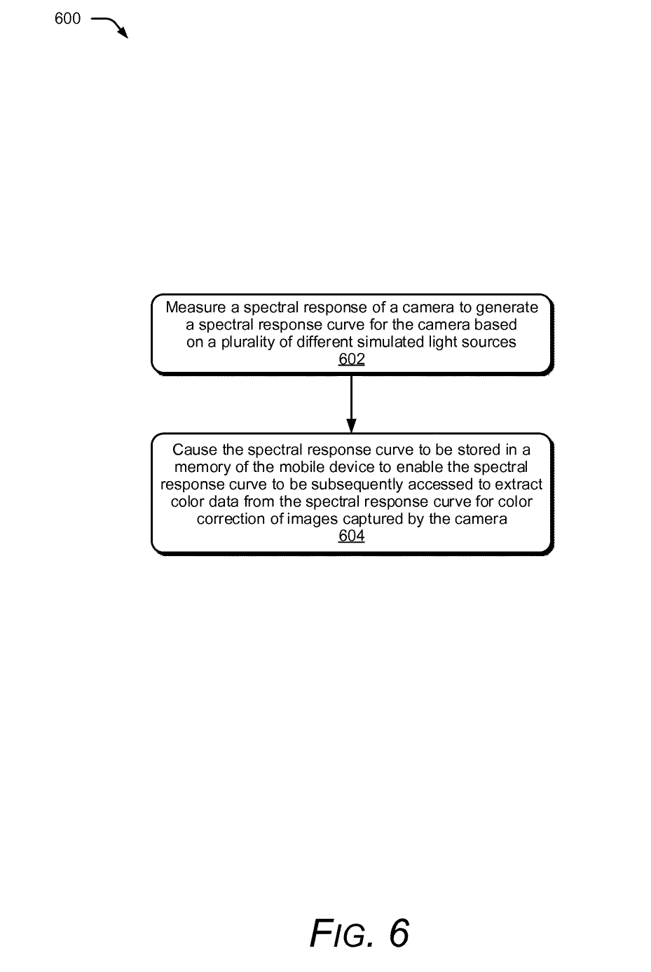

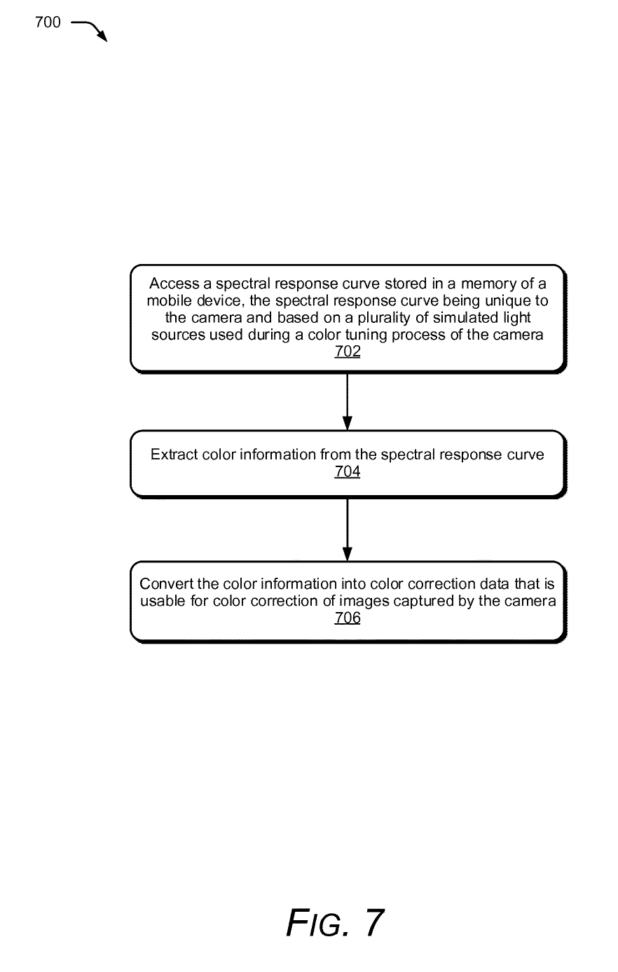

The following discussion describes methods by which techniques are implemented to enable use of methodologies for mobile camera color management. These methods can be implemented utilizing the previously described environment and example systems, devices, and implementations, such as shown in FIGS. 1-5. Aspects of these example methods are illustrated in FIGS. 6 and 7, which are shown as operations performed by one or more entities. The orders in which operations of these methods are shown and/or described are not intended to be construed as a limitation, and any number or combination of the described method operations can be combined in any order to implement a method, or an alternate method.

FIG. 6 illustrates example methods 600 of color tuning a camera using methodologies for mobile camera color management. At 602, a spectral response of a camera is measured based on a plurality of different simulated light sources to generate a spectral response curve for the camera. The light sources can be simulated using any of a variety of light sources, such as a narrow band light source, a rapid LED light source, and so on. The spectral response can be measured using any of a variety of measurement techniques, such as the system described in FIG. 3.

At 604 the spectral response curve is caused to be stored in a memory of the mobile device to enable the spectral response curve to be subsequently accessed to extract color data from the spectral response curve for color correction of images capture by the camera. For example, the mobile device that includes the camera also includes a memory, and the spectral response curve, once measured, can be stored therein. In addition, an algorithm for converting the data from the spectral response curve into a human usable format can also be stored in the memory of the mobile device.

FIG. 7 illustrates example methods 700 of methodologies for mobile camera color management for performing color correction of images captured by a camera. At 702, a spectral response curve stored in a memory of a mobile device is accessed. In implementations, the spectral response curve is unique to the camera and is based on a plurality of simulated light sources used during a color tuning process of the camera. At 704, color information is extracted from the spectral response curve. At 706, the color information is converted into color correction data that is usable for color correction of images captured by the camera. This step can be performed in any suitable way, examples of which are described above. Methods 700 enable the mobile device to self-adjust to any new light source, including light sources for which the camera was not specifically tuned.

### Example Electronic Device

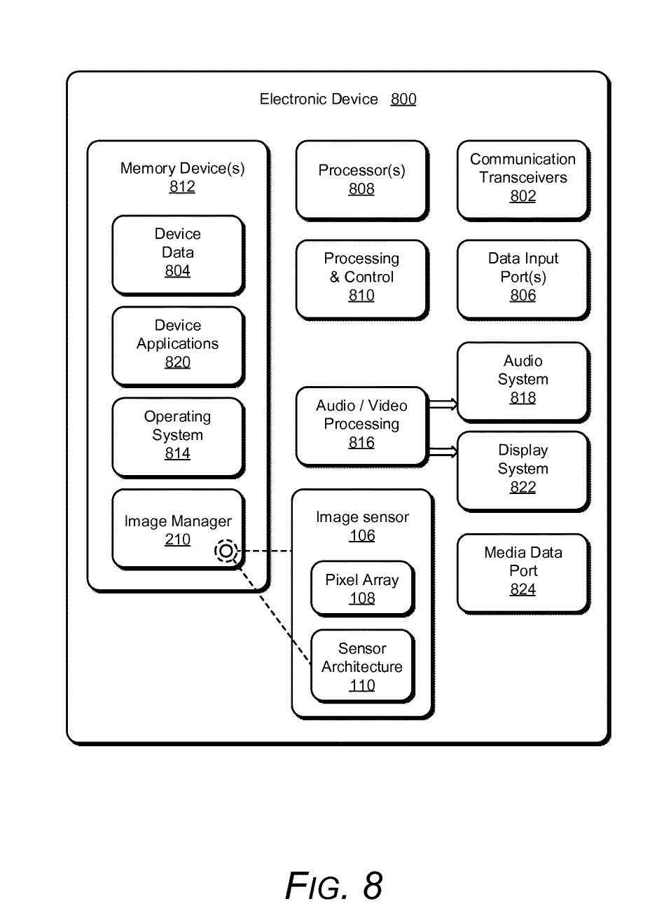

FIG. 8 illustrates various components of an example electronic device 800 that can be implemented as an imaging device as described with reference to any of the previous FIGS. 1-7. The electronic device may be implemented as any one or combination of a fixed or mobile device, in any form of a consumer, computer, portable, user, communication, phone, navigation, gaming, audio, camera, messaging, media playback, and/or other type of electronic device, such as imaging device 102 described with reference to FIGS. 1 and 2, or computing device 302 described with reference to FIG. 3.

Electronic device 800 includes communication transceivers 802 that enable wired and/or wireless communication of device data 804, such as received data, transmitted data, or sensor data as described above. Example communication transceivers include NFC transceivers, WPAN radios compliant with various IEEE 802.15 (Bluetooth™) standards, WLAN radios compliant with any of the various IEEE 802.11 (WiFi™) standards, WWAN (3GPP-compliant) radios for cellular telephony, wireless metropolitan area network (WMAN) radios compliant with various IEEE 802.16 (WiMAX™) standards, and wired local area network (LAN) Ethernet transceivers.

Electronic device 800 may also include one or more data input ports 806 via which any type of data, media content, and/or inputs can be received, such as user-selectable inputs, messages, music, television content, recorded video content, and any other type of audio, video, and/or image data received from any content and/or data source (e.g., other image devices or imagers). Data input ports 806 may include USB ports, coaxial cable ports, and other serial or parallel connectors (including internal connectors) for flash memory, DVDs, CDs, and the like. These data input ports may be used to couple the electronic device to components (e.g., image sensor 104), peripherals, or accessories such as keyboards, microphones, or cameras.

Electronic device 800 of this example includes processor system 808 (e.g., any of application processors, microprocessors, digital-signal-processors, controllers, and the like), or a processor and memory system (e.g., implemented in a SoC), which process (i.e., execute) computer-executable instructions to control operation of the device. Processor system 808 may be implemented as an application processor, embedded controller, microcontroller, and the like. A processing system may be implemented at least partially in hardware, which can include components of an integrated circuit or on-chip system, digital-signal processor (DSP), application-specific integrated circuit (ASIC), field-programmable gate array (FPGA), a complex programmable logic device (CPLD), and other implementations in silicon and/or other hardware.

Alternatively or in addition, electronic device 800 can be implemented with any one or combination of software, hardware, firmware, or fixed logic circuitry that is implemented in connection with processing and control circuits, which are generally identified at 810 (processing and control 810). Hardware-only devices in which an image sensor may be embodied may also be used.

Although not shown, electronic device 800 can include a system bus, crossbar, or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Electronic device 800 also includes one or more memory devices 812 that enable data storage, examples of which include random access memory (RAM), non-volatile memory (e.g., read-only memory (ROM), flash memory, EPROM, EEPROM, etc.), and a disk storage device. Memory device(s) 812 provide data storage mechanisms to store the device data 804, other types of information and/or data, and various device applications 820 (e.g., software applications). For example, operating system 814 can be maintained as software instructions within memory device 812 and executed by processors 808. In some aspects, image manager 210 is embodied in memory devices 812 of electronic device 800 as executable instructions or code. Although represented as a software implementation, image manager 210 may be implemented as any form of a control application, software application, signal-processing and control module, or hardware or firmware installed on image sensor 104 or elsewhere in the electronic device 800.

Electronic device 800 also includes audio and/or video processing system 816 that processes audio data and/or passes through the audio and video data to audio system 818 and/or to display system 822 (e.g., a screen of a smart phone or camera). Audio system 818 and/or display system 822 may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 824. In some implementations, audio system 818 and/or display system 822 are external components to electronic device 800. Alternatively or additionally, display system 822 can be an integrated component of the example electronic device, such as part of an integrated touch interface. Electronic device 800 includes, or has access to, image sensor 104, which also includes the sensor architecture 110, which in turn includes various components, such as the pixel array 108. Sensor data is received from image sensor 104 by image manager 210, here shown stored in memory devices 812, which when executed by processor 808 constructs an image as noted above.

Although embodiment of methodologies for mobile camera color management have been described in language specific to features and/or methods, the subject of the appended claims is not necessarily limited to the specific features or methods described. Rather, the specific features and methods are disclosed as example implementations mobile camera color management.

What is claimed is:

1. A method for color management of a camera in a mobile device, the method comprising:
measuring a spectral response of the camera to generate a spectral response curve for the camera based on a plurality of different simulated light sources; and
causing the spectral response curve to be stored in a memory of the mobile device to enable the spectral response curve to be subsequently accessed to extract color data from the spectral response curve for color correction of images captured by the camera.

2. The method of claim 1, further comprising generating the plurality of different simulated light sources by using a rapid light-emitting diode (LED) light source.

3. The method of claim 1, further comprising generating the plurality of different simulated light sources by using a narrow band light source.

4. The method of claim 1, wherein the color data is extractable to simulate color parameters that are usable for the color correction of the camera.

5. The method of claim 1, further comprising causing a color conversion algorithm to be stored in the memory of the mobile device to enable the color data to be converted into color correction data that is usable for the color correction of the images captured by the camera.

6. A method for color management of a camera in a mobile device, the method comprising:
accessing a spectral response curve stored in a memory of the mobile device, the spectral response curve being unique to the camera and based on a plurality of simulated light sources used during a color tuning process of the camera;
extracting color information from the spectral response curve; and
converting the color information into color correction data that is usable for color correction of the camera.

7. A method as recited in claim 6, further comprising simulating one or more parameters for the color correction based on the extracted color information.

8. A method as recited in claim 6, wherein the color information includes raw RGB values from the spectral response curve; and
the converting includes converting the raw RGB values to a human-usable format by at least mapping the raw RGB values to a human-eye perceived color space.

9. A method as recited in claim 8, wherein the mapping includes using a color correction matrix.

10. A method as recited in claim 8, wherein the mapping includes using a three-dimensional lookup table that contains parameters usable for the color correction.

11. A method as recited in claim 6, wherein the extracting includes calculating one or more parameters for the color correction directly from the spectral response curve.

12. A method as recited in claim 6, wherein the plurality of simulated light sources used during the color tuning process of the camera are based on a narrow band light source.

13. A method as recited in claim 6, wherein the plurality of simulated light sources used during the color tuning process of the camera are based on a rapid light-emitting diode (LED) light source.

14. A system for color management in a camera of a mobile device, the system comprising:
a light generator configured to simulate a plurality of different light sources;
an integrating sphere configured to diffuse light from the simulated plurality of different light sources and transmit diffused light to the camera; and
a central processing unit (CPU) architecture having one or more computer processors configured to:
communicate with the camera to measure a spectral response of the camera based on the diffused light transmitted to the camera;
generate a spectral response curve for the camera; and
cause the spectral response curve to be stored in a memory of the mobile device to enable the spectral response curve to be subsequently accessed for color correction of the camera.

15. A system as recited in claim 14, wherein the camera includes one or more sensors configured to detect the diffused light that is transmitted to the camera.

16. A system as recited in claim 14, wherein the CPU is further configured to cause an algorithm to be stored in the memory of the mobile device, and the algorithm is executable by the mobile device to convert the spectral response curve into color correction data that is usable for the color correction of images captured by the camera.

17. A system as recited in claim 16, wherein the algorithm is configured to enable the mobile device to perform color correction of the images captured by the camera by applying a three-dimensional lookup table that contains one or more parameters for the color correction.

18. A system as recited in claim 16, wherein the algorithm is configured to enable the mobile device to perform color correction of the images captured by the camera by applying a color correction matrix that is derived from the spectral response of the camera and an XYZ color matching function.

19. A system as recited in claim 14, wherein the light generator includes a narrow band light source.

20. A system as recited in claim 14, wherein the light generator includes a rapid light emitting diode (LED) light source.
